(19) United States
(12) Patent Application Publication
(10) Pub. No.: US 2009/0077035 A1
(43) Pub. Date: Mar. 19, 2009

(54) SYSTEM AND METHOD FOR PROVIDING USER-CUSTOMIZED EVENT

(75) Inventors: Young Bae Ku, Seoul (KR); Jung Du Choi, Seoul (KR)

Correspondence Address: Fay Sharpe LLP, 1228 Euclid Avenue, 5th Floor, The Halle Building, Cleveland, OH, 44115-1843, US

(73) Assignee: GMARKET INC., Seoul (KR)

(21) Appl. No.: 12/159,129

(22) PCT Filed: Apr. 19, 2007
(86) PCT No.: PCT/KR2007/001913

§ 371 Date: Jun. 25, 2008

(30) Foreign Application Priority Data
Apr. 19, 2006 (KR) 10-2006-0035256

(51) Int. Cl. G06F 17/30

(52) U.S. Cl. 707/3; 707/E17.014

(57) ABSTRACT

According to the present invention, provided is a method and system for providing an advertisement and event which is customized for web-user, in particular, to a method and system capable of providing a customized advertisement and event by searching an advertisement and event information database based on the searching condition of the obtained web-user information. A method of providing an user-customized event according to the present invention comprises receiving an information of a user accessed to web site; searching an advertisement and event providing information in a database, based on the searching condition of the received user information; and providing an advertisement and an event to the user according to the search result.

### TECHNICAL FIELD

The present invention relates to a method and system for providing an advertisement and event which is customized for web-user, in particular, to a method and system capable of providing a customized advertisement and event by searching an advertisement and event information database based on the searching condition of the obtained web-user information.

### BACKGROUND ART

As to the search result of a searching service web-site of the related art, a page was comprised of a simple search result through a keyword, a banner advertisement that purchased a fixed location, and an advertisement in cooperation with the searching keyword advertisement company (Overture).

In the internet, companies perform an advertisement or PR for increasing a sale. However, as to the user who just want to search information, the advertisement such as a pop up or a banner is just a cost that should be ready to suffer. Thus, the concern of the user sufficient for the expected effect of an actual sale did not happened.

Additionally, as the service customized for each user is required, there is a problem in that the voluntary participation of the user is difficult with the event information that is identically exposed to all customers using the searching service.

### DISCLOSURE OF INVENTION

### Technical Problem

Accordingly, an object of the present invention is to solve at least the problems and disadvantages of the related art. An object of the present invention is to improve the advertisement effect by providing an advertisement and an event customized for a web user to induce the voluntary participation of the web user.

### Technical Solution

In order to accomplish the object, the first aspect of the present invention provides a method of providing an user-customized event, the method comprising: collecting one or more informations of a user accessed to an electronic site; searching an event that provides a goods that matches with the user information among the events that is performing in the electronic site in a database of the electronic site, based on the searching condition of at least one among the collected user informations; and providing the searched event to the user accessed to the electronic site.

The second aspect of the present invention provides a method of providing an user-customized event, the method comprising: receiving a searching word from a user accessed to an electronic site; searching an event that provides a goods that matches with the searching word among the events that is performing in the electronic site in a database of the electronic site, based on the searching condition of the received searching word; and providing the searched event to the user together with a search result due to the searching word.

The third aspect of the present invention provides a method of providing an user-customized event, the method comprising: storing an event that is performing in an electronic site by matching with a search result of a specific searching word; receiving a searching word from a user accessed to the electronic site; and providing an event to the user together with a search result due to the searching word, in case the event that matches with the received searching word exists in the database.

The fourth aspect of the present invention provides a method of providing an user-customized event, the method comprising: determining whether a searching word is received from a user accessed to an electronic site or not; searching an event that provides a goods that matches with the searching word among the events that is performing in the electronic site in a database of the electronic site, and providing the searched event to the user together with a search result due to the searching word, based on the searching condition of the received searching word, in case the searching word is received from the user accessed to the electronic site; and searching an event that provides a goods that matches with the searching word among the events that is performing in the electronic site in the database, and providing the searched event to the user accessed to the electronic site, after collecting one or more informations of a user accessed to the electronic site, based on the searching condition of the collected one or more user informations, in case the searching word is not received from the user accessed to the electronic site in a predetermined time.

The present invention also provides a system of providing an user-customized event by using an electronic site, the system comprising: an information collector that collects an information of a user accessed to the electronic site or a searching word; a database that stores and manages an event relating to a product or a promotion goods corresponding to the information of the user or the searching word; and a main server that searches an event on a product or a promotion goods that matches with the information of the user or the searching word among the events that is performing in the electronic site, and provides the searched event to the user accessed to the electronic site, based on the searching condition including at least one of the collected user information or the searching word.

### BRIEF DESCRIPTION OF THE DRAWINGS

FIG. 1 is a block diagram illustrating a system for providing an advertisement and an event customized for a web-user according to an embodiment of the present invention;

FIG. 2 is a flowchart illustrating a method of providing an advertisement and an event customized for a web-user according to an embodiment of the present invention;

FIG. 3 is a flowchart illustrating a method of providing an advertisement and an event customized for a web-user according to another embodiment of the present invention.

### BEST MODE FOR CARRYING OUT THE INVENTION

Hereinafter, exemplary embodiments of the present invention will be described in detail with reference to the attached drawings.

In this document, an event means an information which is additionally provided in addition to the basic information that is provided for a user according to the function of the web-site.

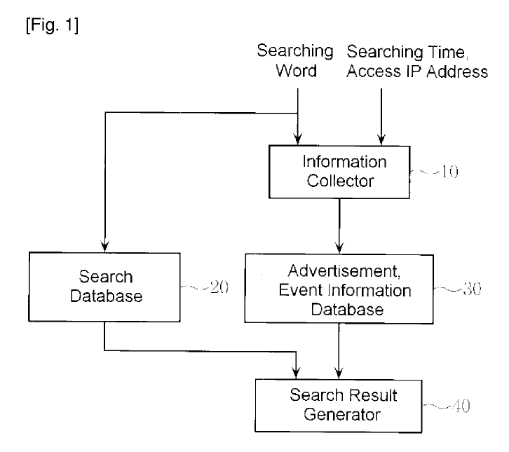

FIG. 1 is a block diagram illustrating a system for providing an advertisement and an event customized for a web-user according to an embodiment of the present invention;

Referring to FIG. 1, the system for providing an advertisement and an event customized for a web-user comprised of an information collector 10, a search database 20, an advertisement and event information database 30, and a search result generator 40.

The information collector 10 receives the setting information of an advertisement and event which is wanted to be provided from the user, collects the information of the user who is accessed to web-site. The search database 20 stores the search result corresponding to the searching word inputted by the user.

The advertisement and event information database 30 stores the advertisement and event providing information corresponding to the information of the user collected from the information collector 10, the setting information inputted by the user and the searching word inputted by the user.

The search result generator 40 combines the search result of the search database 20 and the search result of the advertisement and event information database 30 to generate a search result screen.

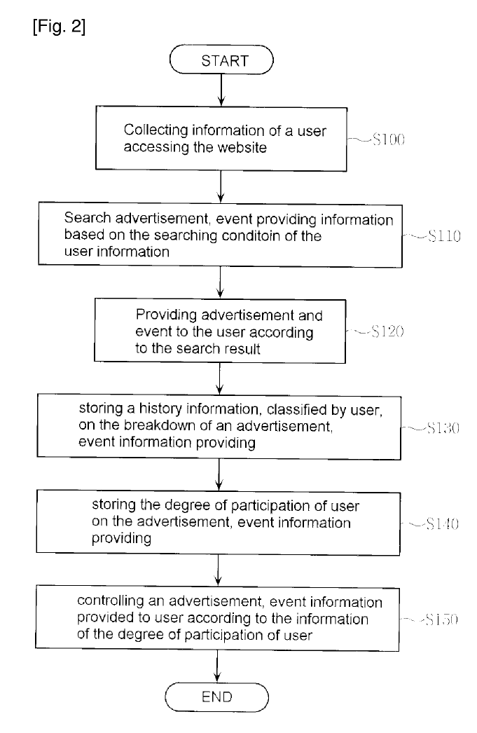

FIG. 2 is a flowchart illustrating a method of providing an advertisement and an event customized for a web-user according to an embodiment of the present invention;

Referring to FIG. 2, the information of the user who is accessed to web-site is collected (S100). In case the user does not login to web-site, the time slot of the user access, the regional information of the user living obtained through the access IP address information of the user can be collected. Further, the concern area of the user can be estimated through the searching word inputted by the user.

In case the user login to web-site, a basic member information such as address, sex, age, job, and hobby, an information of joined community, an information of favorite search, and an information of goods review can be collected. Further, the searching information that the user searched in advance and the purchase information that the user purchased in advance also can be collected.

Additionally, the advertisement and event setting information which is wanted to be provided from the user can be inputted. For example, in case the user is interested in the computer, it can be set to provide an advertisement and event on computer.

The advertisement and event providing information is searched in an advertisement and event information database 30 based on the searching condition including the setting information of the user and the collected user information (S110). The advertisement and event information database 30 may include the advertisement and event providing information corresponding to the residential district information of the user. The advertisement and event information database 30 may include the advertisement and event providing information corresponding to the previous searching information and the purchase information of the user.

The advertisement and event information database 30 may include the advertisement and event providing information corresponding to the member information of the user such as address, sex, age, job, and hobby, the information of joined community, the information of favorite search, and the information of goods review.

The advertisement and the event are provided to the user according to the searched content (S120).

The advertisement inputted by the user and the advertisement and the event information related to the event setting information among the searched advertisement and event information can be provided preferentially. Additionally, the advertisement and the event information related to the searching word inputted by the user among the searched advertisement and event information can be provided preferentially.

For example, in case the setting information that tells the user is interested in the field of computer is inputted, while it is determined from the collected user information that the user is also interested in the field of sports, preferentially, the advertisement and event information related to the computer. In case the advertisement and event information related to the computer does not exist, then, the information on sports can be provided.

The event information provided to the user can be a supporting goods information that can support a supporter s organization with a given amount of money by purchasing goods, a promotion goods information, a sale/auction information, a goods information, and an employment information. Additionally, the event information provided to the user can be a questionnaire, a discount coupon, and an event application information.

For example, in case it is determined from the collected information that the user who inputted digital camera as a searching word is interested in MP3, the event such as a supporting goods information related to MP3, a questionnaire, and a promotion goods information can be provided, additionally, the advertisement on a new MP3 product can be provided.

The history information on the details of the advertisement and event information providing is classified by the user to be stored (S130).

In case the user login to website, the history information on the details of the advertisement and event information providing is classified by the user to be stored, thereby, it can be used as reference materials on the advertisement and event information providing when the user accesses in the next time. The degree of participation of the user on the advertisement and event information providing is stored (S140).

In case the user login to website, the information of the degree of participation such as the click of the user on the advertisement and event information providing, and the purchase of the advertised goods can be stored.

The advertisement and event information provided to the user is controlled according to the information of the degree of participation of the user on the previous advertisement and event information providing (S150).

Referring to the information of the degree of participation of the user on the previous advertisement and event information providing, the degree of participation of the user can be enhanced by controlling the content of the advertisement and event information which is newly provided to the user.

For example, in case the advertisement and event information on sports equipment is provided to a user who is determined to be interested in sports equipment and computer products while the degree of participation of the user was low, then, the advertisement and event information on computer products instead of sports equipment can be provided.

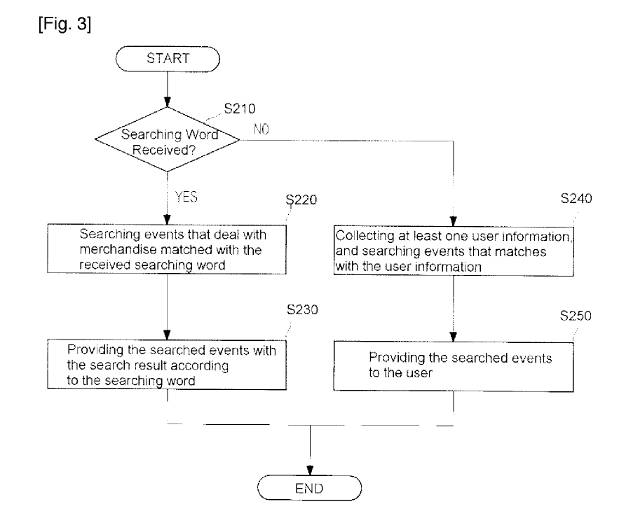

Now referring to FIG. 3, another embodiment of the present invention will be described. FIG. 3 is a flowchart illustrating a method of providing an advertisement and an event customized for a web-user according to another embodiment of the present invention.

When a user accesses the electronic website according to the present invention, the electronic website waits for the user inputting a searching word (S210). The searching word does not have to be a word related with events or advertisements, and may be any word for searching any internet contents. Moreover there may be a time limitation for the electronic website to wait for the searching word from the user.

If the electronic website receives a searching word from the user, the electronic website does not only search the search database (20), but also searches the advertisement/event information database (30) to find out whether there are any events or advertisements related with that searching word (S220). Then the electronic website provides the search result with the searched events for the user (S230).

If the electronic website does not receive any searching word from the user in said time limitation, the electronic website collects at least one user information, and searches the advertisement/event information database (30) to find out whether there are any events or advertisements related with the user information (S240). Then the electronic website provides the searched events for the user (S250).

### INDUSTRIAL APPLICABILITY

The method and system for providing an advertisement and event that is customized for web-user according to the present invention is capable of enhancing the advertisement effect by inducing the voluntary participation of the web user. It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of providing a user-customized event, the method comprising:
collecting one or more information of a user accessed to an electronic site;
searching an event that provides a goods that matches with the user information among the events that is performing in the electronic site in a database of the electronic site, based on the searching condition of at least one among the collected user information; and
providing the searched event to the user accessed to the electronic site.

2. A method of providing a user-customized event, the method comprising:
receiving a searching word from a user accessed to an electronic site;
searching an event that provides a goods that matches with the searching word among the events that is performing in the electronic site in a database of the electronic site, based on the searching condition of the received searching word; and
providing the searched event to the user together with a search result due to the searching word.

3. A method of providing a user-customized event, the method comprising:
storing an event that is performing in an electronic site by matching with a search result of a specific searching word;
receiving a searching word from a user accessed to the electronic site; and
providing an event to the user together with a search result due to the searching word, in case the event that matches with the received searching word exists in the database.

4. A method of providing a user-customized event, the method comprising:
determining whether a searching word is received from a user accessed to an electronic site or not;
searching an event that provides a goods that matches with the searching word among the events that is performing in the electronic site in a database of the electronic site, and providing the searched event to the user together with a search result due to the searching word, based on the searching condition of the received searching word, in case the searching word is received from the user accessed to the electronic site; and
searching an event that provides a goods that matches with the searching word among the events that is performing in the electronic site in the database, and
providing the searched event to the user accessed to the electronic site, after collecting one or more information of a user accessed to the electronic site, based on the searching condition of the collected one or more user information, in case the searching word is not received from the user accessed to the electronic site in a predetermined time.

5. The method of any one of claims 1 to 4, wherein the event is a promotion goods event performing in the electronic site, and the promotion goods event stored in the database is classified by the name of the promotion goods to be stored.

6. The method of any one of claims 1 to 4, wherein the event is a goods advertisement sold through the electronic site, and the goods advertisement stored in the database is classified by the goods which is treated in the goods advertisement to be stored.

7. The method of claim 1, wherein the user information includes a user location information obtained from the access IP address of the user, while an event is matched in the database according to the access location of the user.

8. The method of claim 1, wherein the user information includes a searching history or a purchase history in the electronic site, and an event is matched in the database according to the searching history or the purchase history.

9. The method of claim 1, wherein the user information includes the user s registration information in the community which is operated in the electronic site, and an event is matched in the database according to the community in which the user registered.

10. The method of claim 1, wherein an event is matched in the database according to the time slot in which the user accesses to the electronic site, and the user information is the time during which the user accesses to the electronic site.

11. The method of any one of claims 1 to 4, further comprising the step of storing and managing the details of event provided, in case the searched event is provided to the user accessed to the electronic site.

12. The method of any one of claims 1 to 4, further comprising the step of storing and managing the degree of participation of the user, in case the searched event is provided to the user accessed to the electronic site.

13. The method of claim 12, further comprising the step of controlling the event which is provided to the user accessed to the electronic site according to the degree of participation of the user.

14. The method of any one of claims 1 to 4, further comprising the step of setting event information that the user wants to be provided, and the step of providing the searched event to the user accessed to the electronic site is performed, by reflecting the event information that is set.

15. A system of providing a user-customized event by using an electronic site, the system comprising:
an information collector that collects an information of a user accessed to the electronic site or a searching word;
a database that stores and manages an event relating to a product or a promotion goods corresponding to the information of the user or the searching word; and
a main server that searches an event on a product or a promotion goods that matches with the information of the user or the searching word among the events that is performing in the electronic site, and provides the searched event to the user accessed to the electronic site, based on the searching condition including at least one of the collected user information or the searching word.
